(19) United States
(12) Patent Application Publication
(10) Pub. No.: US 2009/0185236 A1
(43) Pub. Date: Jul. 23, 2009

(54) IMAGE BINARIZATION USING DYNAMIC SUB-IMAGE DIVISION

(76) Inventor: Yijun ZENG, Montreal (CA)

Correspondence Address: LADAS & PARRY LLP, 224 SOUTH MICHIGAN AVENUE, SUITE 1600, CHICAGO, IL, 60604, US

(21) Appl. No.: 12/356,945

(22) Filed: Jan. 21, 2009

Related U.S. Application Data
(60) Provisional application No. 61/006,517, filed on Jan. 17, 2008.

(51) Int. Cl. H04N 1/387; G06K 9/40; G06K 9/36; H04N 1/40

(52) U.S. Cl. 358/450; 382/274; 382/284; 358/448; 382/291

(57) ABSTRACT

Image binarization methods and devices for converting a grayscale image into a black and white binary image are provided. The grayscale image is divided into sub-images dynamically created from pixel to pixel containing a given pixel as well as neighboring pixels. The color value of the pixels in the sub-image is averaged and the threshold between the given pixel and the average color value is determined. Therefore, at a certain color value, this given pixel is converted to white and at another color value the pixel is converted black. The foregoing is effectuated pixel by pixel in a dynamic fashion evaluating each pixel relative to its neighboring pixels in order to produce a binary image. A small sub-image provides greater clarity whereas a large sub-image gives a better broad view. In an image having a border surrounding characters, a smaller sub-image is used for the characters and the larger sub-image is used for the border thereby providing two binary images. The border in the image obtained for the characters is removed to be combined with the image obtained for a clear border.

### CROSS-REFERENCE TO RELATED APPLICATIONS

The present application requests priority on U.S. Provisional Application No. 61/006,517 filed on Jan. 17, 2008 and incorporated by reference herein in its entirety.

### FIELD OF THE INVENTION

The present invention relates to image binarization. More specifically, but not exclusively, the present invention relates to image binarization using dynamic sub-image division.

### BACKGROUND OF THE INVENTION

Image binarization converts an image of gray levels (grayscale) to a black and white image. The simplest way to use image binarization is to choose a threshold value, and classify all pixels with values above this threshold as white, and all other pixels as black. The problem then is how to select the correct threshold. In many cases, finding one threshold compatible to the entire image is very difficult, and sometimes even impossible. Therefore, adaptive image binarization is needed where an optimal threshold is chosen for each image area. When a different threshold can be used for different regions in the image, this is known as adaptive thresholding or as local or dynamic thresholding [see Pierre D. Wellner, “Adaptive Thresholding for the Digital Desk”, http://www.xrce.xerox.com/publis/cam-trs/pdf/1993/epc-1993-110.pdf.]

Image binarization is a useful process in a variety of different fields such as public safety for example.

In many public sites, such as parking lots, street intersections, highways, surveillance cameras are installed for public safety purposes or management. The installed cameras produce a huge number of images with important information. It is therefore critical to provide an effective method for precisely and rapidly retrieving this information from the images. Often, at sites where surveillance cameras take images, the luminance is usually uneven on the objects in the images making it difficult in producing a binarized image of good quality.

Optical character recognition or OCR methods, which work on a 1-bitimage, are useful in retrieving information from images. The images provided by the surveillance cameras may seem black and white to the naked eye but in fact they are in grayscale. Binarizing the images taken by the cameras to be 1-bit is a key step for OCR to precisely retrieve information from the images.

Binarizing a grayscale image converts for example an 8-bit grayscale image into a 1-bit black and white image. The key here is to determine during conversion whether a pixel on the original image should be converted to be black or white.

### Converting to a Grayscale Pixel to a Black or White Pixel

In an example of a grayscale image, pixels are represented by an 8-bit set. The value of an 8-bit set is in the range [0, 255], which indicates the color depth of pixels. For a 1-bit image, its pixels are represented by 1 bit. Therefore, a pixel of a 1-bit image has only two possible color values, either 0 or 1.

To binarize a grayscale image to a corresponding binary image, we need a color value called a threshold to determine whether a pixel in the original image should be converted to a black or white pixel in its corresponding binary image. In essence we assign a color value to the pixel: 0 (white) or 1 (black). Global threshold

Using a single threshold for all pixels in a grayscale image, (e.g. global threshold), to binarize a grayscale image is the simplest way. FIG. 1 shows the result (Binarized) of binarization of a grayscale car plate image (Original) using a global threshold to assign a black or white color value to each pixel. The original image is evenly lit and as such provides a good binarized image.

Yet, in most cases and especially in sites under surveillance, photographed objects are not properly or evenly lit and thus do not provide clear images.

FIG. 2 shows the binarized result (Binarized) of a grayscale image (Original) of an unevenly lit car plate using again a global threshold. In the right-hand portion (rpo) of the original image the color of the background is almost as dark as foreground of the left-hand portion (lpo) of the original image. Thus, the right-hand portion (rpb) of the binarized image becomes black and unrecognizable even if the background and foreground in the right-hand portion of the original image is distinguishable to the naked eye.

The above unacceptable result is due to uneven luminance on the car plate when the surveillance camera captured this image. When binarizing such an image with a global threshold, the background pixels in the right-hand portion are too dark and as such their color value is lesser than the global threshold, thus these pixels are assigned the color value 1 and the resulting background in the right-hand portion of the binarized image is converted to black.

### Adaptive Thresholding

Since the use of a global threshold does not provide a binarized image of sufficient quality, using different thresholds in different parts of the image to be binarized is used to binarize an unevenly lit image. This is called adaptive thresholding and it is a commonly used method of image binarization.

As shown in FIG. 1, images with even luminance are easy to handle and the result of binarization on such images is satisfactory. The basic idea of adaptive thresholding is to divide the image to be binarized into sub-images. The sub-image should be small enough so that each one can be considered as being evenly lit. But the sub-images should also be big enough to contain sufficient information.

As shown in FIG. 3, to distinguish whether a pixel is in the background or the foreground, the value of the threshold for the sub-image A must be different from that of for the sub-image B. In this case, we need to take special care of the pixels crossing the border between two sub-images. There should be a smooth transition from one sub-image to another of the threshold value of the pixels across a border between the two sub-images. The foregoing is difficult to achieve with known techniques. One attempt of solving this problem is interpolation which is used to smoothen the threshold across the border between sub-images as described in K. Castleman, “Digital Image Processing”, Prentice-Hall Signal Processing Series, 1979. But the interpolation is just an approximation; it does not really indicate how the luminance on the object smoothly transits from a point to another.

A drawback of known methods of binarization is that they do not provide satisfactory images with sufficient detail in a timely fashion.

### OBJECTS OF THE INVENTION

An object of the present invention is to provide an image binarization method using dynamic sub-image division.

### SUMMARY OF THE INVENTION

In accordance with an aspect of the present invention there is provided a method of binarizing a grayscale image into a black and white binary image, said method comprising:

selecting a given pixel (P) in the grayscale image; determining the color value (V_{P}) of P;

providing a sub-image (Subl_{P}) comprising P as well as a number of neighbouring pixels;

determining the average color value (A_{P}) of all the pixels in Subl_{P};

calculating the threshold (T_{P}) of P by multiplying A_{P} by a threshold coefficient (C);

converting P to black if V_{P}≦T_{P} or to white if V_{P}>T_{P};

repeating the above steps for each pixel of the grayscale image that is desired to be converted; and

obtaining a resulting black and white binary image.

In accordance with an aspect of the present invention, there is provided a method of binarizing a grayscale image comprising a border surrounding characters into a black and white binary image with a clear border and clear characters, said method comprising:

obtaining first and second binary images of the grayscale image by dividing the grayscale image into sub-images for determining if a pixel is to be converted into white or black based on its threshold as compared to the average color value of its sub-image, wherein one of the first and second binary images provides a clear border and the other of the first and second binary images provides clear characters;

removing the border in the binary image providing characters to provide a binary image without a border; and

combining the binary image without a border with the binary image having a clear border so as to obtain a combined binary image having both a clear border and clear characters.

In accordance with an aspect of the present invention, there is provided a device for binarizing a grayscale image into a black and white binary image, said device comprising;

a scanner for scanning the pixels of the grayscale image; and

a controller for receiving information from the scanner, said controller:

selecting a given pixel (P) in the grayscale image; determining the color value (V_{P}) of P;

providing a sub-image (Sublₚ) comprising P as well as a number of neighbouring pixels;

determining the average color value (A_{P}) of all the pixels in Subl_{P};

calculating the threshold (T_{P}) of P by multiplying A_{P} by a threshold coefficient (C);

converting P to black if V_{P}≦T_{P} or to white if V_{P}>T_{P};

repeating the above steps for each pixel of the grayscale image that is desired to be converted; and

obtaining a resulting black and white binary image.

In accordance with an aspect of the present invention, there is provided a device for binarizing a grayscale image comprising a border surrounding characters into a black and white binary image with a clear border and clear characters, said device comprising:

a scanner for scanning the pixels of the grayscale image;

a controller for receiving information from the scanner, said controller;

obtaining first and second binary images of the grayscale image by dividing the grayscale image into sub-images for determining if a pixel is to be converted into white or black based on its threshold as compared to the average color value of its sub-image, wherein one of the first and second binarized images provides a clear border and the other of the first and second binarized images provides clear characters;

removing the border in the binary image with clearer characters to provide a binary image without a border; and

combining the binary image without a border with the binary image having a clear border so as to obtain a combined binary mage having both a clear border and clear characters.

Other objects, advantages and features of the present invention will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 shows a grayscale image of an evenly lit car plate and its corresponding binarized image obtained by using the prior art global threshold method;

FIG. 2 shows an grayscale image of an unevenly lit car plate and its corresponding binarized image obtained by using the prior art global threshold method;

FIG. 3 shows a grayscale image divided into sub-images for binarization in accordance with the prior art adaptive threshold method;

FIG. 4 shows a grayscale image when divided by dynamic sub-image division in accordance with a non-restrictive illustrative embodiment of the present invention;

FIG. 5A is a schematic representation of a grayscale image and the sub-image of a pixel of this grayscale image obtained with dynamic sub-image division in accordance with a non-restrictive illustrative embodiment of the present invention;

FIG. 5B is an enlarged view of the sub-image of FIG. 5A;

FIGS. 6A, 6B and 6C are examples of grayscale images and their corresponding binarized images having been obtained with dynamic sub-image division in accordance with a non-restrictive illustrative embodiment of the present invention;

FIG. 7 shows a grayscale image and its corresponding binarized image obtained for clear characters with dynamic sub-image division in accordance with a non-restrictive illustrative embodiment of the present invention;

FIG. 8 shows another binarized image obtained from the grayscale image of FIG. 7 for a clear border with dynamic sub-image division in accordance with a non-restrictive illustrative embodiment of the present invention;

FIG. 9 shows a grayscale image and two corresponding binarized images obtained for clear characters and a clear border respectively with dynamic sub-image division in accordance with a non-restrictive illustrative embodiment of the present invention;

FIG. 10 shows two binarized images obtained from the grayscale image of FIG. 7 for clear characters and for a clear border respectively with dynamic sub-image division in accordance with a non-restrictive illustrative embodiment of the present invention;

FIG. 11 is a schematic theoretical representation of a binarized image obtained for a clear border;

FIGS. 12A, 12B, 12C and 12D are schematic theoretical representations of line black density histograms for the top, bottom, left and right borders, respectively, of a theoretical binarized image obtained for a clear border;

FIGS. 13A, 13B, 13C and 13D shows four of the same binarized image obtained for a clear border with the border positions thereof being identified;

FIG. 14 shows the binarized image of FIGS. 13A-13D with the found border contour;

FIG. 15 is a schematic representation of another binarized image obtained for clear characters from the same grayscale image as the binarized image in FIGS. 13A-13D with the contour shown in FIG. 14 being mapped out thereon;

FIG. 16 is binarized image of FIG. 15 with the border contour and border area having been removed;

FIGS. 17A, 17B and 17C are the examples of grayscale images and their corresponding binarized images shown in FIGS. 6A, 6B and 6C respectively with additional corresponding binarized images having had their black borders removed;

FIG. 18 is an example of the grayscale image of FIG. 7 and its corresponding binarized image having been obtained with dynamic sub-image division for clear characters as well as its corresponding binarized image of FIG. 8 having been obtained for a clear border with an additional binarized image having had the black border removed;

FIG. 19 is an example of the grayscale image of FIG. 9 and its corresponding binarized image having been obtained with dynamic sub-image division for clear characters as well as its corresponding binarized image having been obtained for a clear border with an additional binarized image having had the black border removed;

FIG. 20A is an example of a grayscale image;

FIGS. 20B, 20C and 20D are respective binarized images of the grayscale image of FIG. 20A having been obtained with different sub-image sizes;

FIGS. 21A and 21B are a grayscale image and its corresponding binarized image, respectively, the latter having been obtained with dynamic sub-image division in accordance with a non-restrictive illustrative embodiment of the present invention;

FIGS. 22A and 22B are a grayscale image and its corresponding binarized image respectively, the latter having been obtained with dynamic sub-image division in accordance with a non-restrictive illustrative embodiment of the present invention;

FIGS. 23A and 23B are a grayscale image and its corresponding binarized image respectively, the latter having been obtained with dynamic sub-image division in accordance with a non-restrictive illustrative embodiment of the present invention;

FIG. 24 shows examples of a grayscale images with characters that are very small and with a very small contrast of foreground and background as well as their respective resulting binarized images; and

FIG. 25 is an example of a grayscale image and two corresponding binarized images having been obtained using different sub-image sizes.

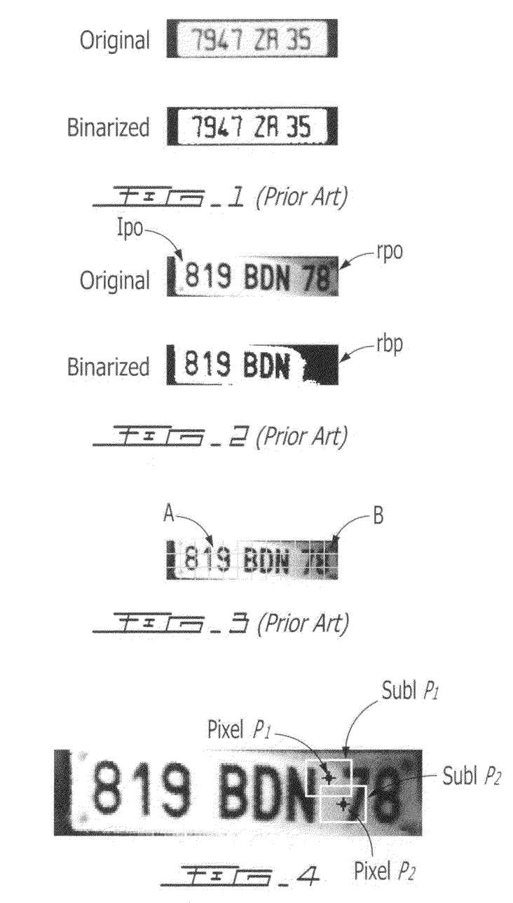

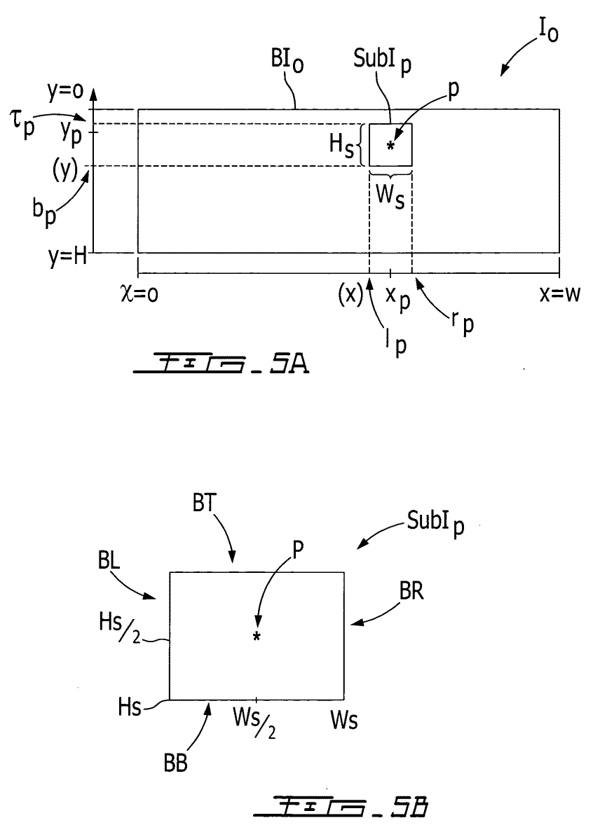

### DETAILED DESCRIPTION OF ILLUSTRATIVE EMBODIMENTS

Generally stated, in an embodiment of the invention, an image binarization method is provided for converting a grayscale photograph or video image into a black and white binary image that provides sufficient detail.

This method divides the original image into sub-images. Instead of simply statically dividing a grayscale image into a predetermined set of sub-images, a given sub-image is dynamically created from pixel to pixel. More specifically, each sub-image is a window that contains a central first pixel as well as neighboring pixels. The next sub-image will contain a central second pixel, adjacent to the first pixel as well as neighboring pixels and sub-mages will be created so forth from pixel to pixel. The color density or value of the neighboring pixels or of all the pixels in the sub-image is averaged and the threshold (i.e. the local contrast) between the central pixel and its neighboring pixels is calculated. A certain predetermined percentage of local contrast is used to calculate whether or not the central pixel is below or above the threshold. Therefore, at a certain color value, the pixel is converted to white and at another color value the pixel is converted black. The foregoing is effectuated pixel by pixel in a dynamic fashion evaluating each pixel relative to its neighboring pixels in order to produce a binarized image.

By using these dynamic sub-image divisions which move from one pixel to another rather than being preset, a more detailed black and white image is provided. In essence, local contrast is calculated rather than general contrast which gives a much clearer and much more precise image and would provides for a smooth threshold transition of the pixels across the border between two sub-images. The amount of neighboring pixels in a given sub-image is also predetermined. A small sub-image provides greater clarity whereas a large sub-image gives a better broad view. For example, in car plates, the small sub-image is used for reading the license number, whereas for the border a larger sub-image is used. The two binary images are combined to give a full view of the border with the plate numbers therein.

With reference to the appended drawings, a non-restrictive illustrative embodiment of the present invention will now be described herein so as to exemplify the invention and not limit the scope thereof.

1—Binarization with Dynamic Sub-Images

Since certain grayscale images such as car plates for example cannot be taken under the same luminance at surveillance sites, tools are required to treat these images in order to provide adequate binary images which will allow to clearly view important information such as a license plate number for example. In an illustrative embodiment, the present invention provides an algorithm for binarization with dynamic sub-images. The foregoing, in one example provides to binarize images for OCR.

### 1.1 Scheme of the Algorithm

The algorithm of the present invention provides for calculating a threshold for each pixel in its own sub-image. For a given pixel P, its sub-image Subl_{P} is a rectangular portion or window of the original grayscale image. The position of P is at the center of its sub-image Subl_{P}. The size of sub-image Sublₚ should be small enough so that the sub-image can be considered as with even luminance on it and should also be enough large to contain enough information.

FIG. 4 shows an example of two pixels P₁ and P₂ of a grayscale image and their sub-images Subl_{P}, Subl_{P2} respectively. As shown, each pixel P₁ and P₂ is positioned at the centre of its respective sub-image Subl_{P1} Subl_{P2}.

For the sub-image Subl_{P} of a given pixel P, the color value of each pixel within the sub-image Subl_{P} is determined and the average color value is calculated for all pixels within this sub-image Subl_{P}. The threshold of pixel P is a predetermined percentage of this average color value. Therefore during binarization, P is converted to white if its color value is larger than its threshold, and black if its color value is smaller than its threshold.

In this binarization scheme, certain important factors are the size of the sub-image for each pixel and the threshold coefficient (e.g. the percentage) used for calculating the threshold from the average color value in the sub-image.

### 1.2 The Algorithm

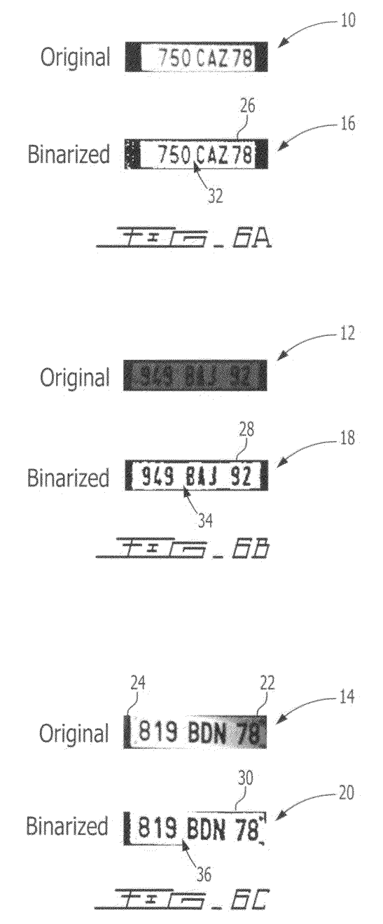

With reference to FIGS. 5A and 5B, a grayscale image lo, that is to be binarized, has a width Wand a height H. A fixed rectangle size for the sub-images Subl_{P1}, of all the pixels of the image lo is predetermined. In essence, a fixed number of pixels along W of lo will be chosen to provide the width Ws of a sub-image Subl_{P}, and a fixed number of pixels along H of lo will be chosen to provide the height Hs of the sub-image Subl_{P} (where 0<Ws≦W and 0<Hs≦H), and C is a threshold coefficient used to calculate the threshold from the average color value. C is a predetermined coefficient (such as a percentage of contrast).

A given pixel P is positioned at (x_{P}, y_{P}) and has a color value V_{P} that is determined. More specifically, x_{P} is the position of P along W of lo and y_{P} is the position of P along the height H of the image lo. The coordinates of the sub-image Subl_{P} of pixel P are (l_{P}, t_{P}, r_{P}, b_{P}). More specifically, l_{P} is the position of the left border of sub-image Subl_{P}, along the width W of the image lo, t_{P} is the position of top border of sub-image Subl_{P} along the height H of the image lo, r_{P} is the position of the right border of sub-image Subl_{P} along the width W of the image lo, and b_{P} is the position of the bottom side of sub-image Subl_{P} along the height H of the image lo.

The algorithm is described as follows:

Step 1: calculate the coordinates of Subl_{P}:

$${I}_{p} = \{ \begin{matrix}0 , & if & 0 \leq {x}_{p} < Ws / 2 ; \\ {x}_{p} - Ws / 2 , & if & Ws / 2 \leq {x}_{p} < W - Ws / 2 ; \\ W - Ws / 2 & if W \text{-} & Ws / 2 \leq {x}_{p} < W ;\end{matrix} \\ {t}_{p} = \{ \begin{matrix}0 , & if & 0 \leq {y}_{p} < Hs / 2 ; \\ {y}_{p} - Hs / 2 , & if & Hs / 2 \leq {y}_{p} < H - Hs / 2 ; \\ H - Hs / 2 & if H \text{-} & Hs / 2 \leq {y}_{p} < H ;\end{matrix} \\ {r}_{p} = \{ \begin{matrix}Ws , & if & 0 \leq {x}_{p} < Ws / 2 ; \\ {x}_{p} + Ws / 2 , & if & Ws / 2 \leq {x}_{p} < W - Ws / 2 ; \\ W , & if W \text{-} & Ws / 2 \leq {x}_{p} < W ;\end{matrix} \\ {b}_{p} = \{ \begin{matrix}Hs , & if & 0 \leq {y}_{p} < Hs / 2 ; \\ {y}_{p} + Hs / 2 , & if & Hs / 2 \leq {y}_{p} < H - Hs / 2 ; \\ H , & if H \text{-} & Hs / 2 \leq {y}_{p} < H ;\end{matrix}$$

Step 2: calculate, the average of the color value A_{P} of all pixels in Subl_{P}. A_{P}=sum of the color value of each pixel in Subl_{P}/number of pixels in Subl_{P}.

Step 3: calculate the threshold T_{P} of P: T_{P}=C×A_{P}.

Step 4: binarize pixel P:

$$P is \{ \begin{matrix}black , & if {V}_{p} \leq {T}_{p} ; \\ white , & if {V}_{p} > {T}_{p} .\end{matrix}$$

Each of these four steps is repeated on the image lo pixel by pixel until all pixels or the desired number of pixels have been converted to either black and white thereby providing a binarized image.

P should be at the centre of Subl_{P} where Ws/2 and Hs/2 correspond.

Therefore, it should be noted that when calculating coordinates of a sub-image Subl_{P} in Step 1, for a given pixel P, if the distance from the position (x_{P}, y_{P}) of P to the borders BL, BR, BT and BB of the image lo is less than ½ of the width Ws or height Hs of the sub-image Subl_{P}, then the center of this sub-image Subl_{P} does not correspond to the position of P. In this case, we align the border of the sub-image Subl_{P} of P to the border Blo of the image lo.

### 1.3 Examples

What follows are a few results exemplifying the above discussed algorithm for Binarization with Dynamic Sub-images.

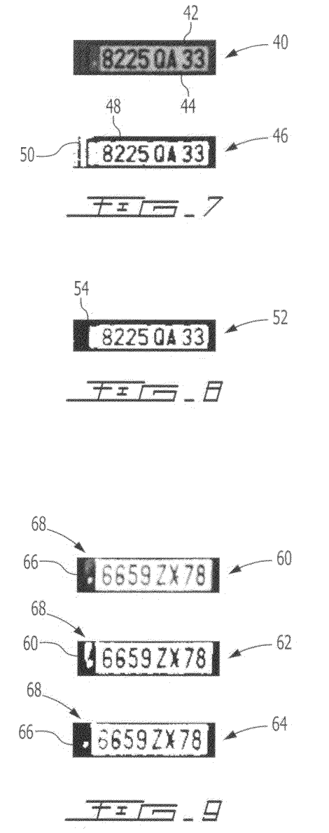

FIGS. 6A, 6B and 6C respectively show three car plate original grayscale images 10, 12 and 14 and their corresponding binarized images 16, 18, and 20 respectively.

Images 10, 12 and 14 were taken under very different luminance conditions. Image 10 was lit evenly. Image 12 received light that was weaker than image 10 and uneven. Image 14 received even less light. In image 12, the background is supposed to be white, but looks almost as dark as the foreground of image 10. As for image 14 which received uneven luminance, the background near its right end 22 looks almost as dark as the foreground in its left end 24.

However, when the three images 10, 12 and 14 were binarized in accordance with the present invention the characters in all three binarized images 16, 18 and 20 are clear enough for OCR.

### 2—The Parameters for Binarization

As mentioned above, the factors in the algorithm of the present invention include the size of the sub-image and the threshold coefficient used for calculating the threshold from the average color value in the sub-image.

With respect to recognizing characters in a grayscale image, in one non-limiting example, it was found that a binarization result of satisfactory quality is achieved when choosing a width and height for the sub-image that is 1.5 times the width of these characters. Such a sub-image size provides for the present algorithm to produce clear good characters in the binarized images for OCR to recognize. In one example, the width of most of the characters was about 12 pixels. As such a character width of 12 pixels was set and therefore the sub-image was set with a height and width of 18 pixels (1.5 times of the character width), therefore the sub-image contains 324 pixels.

However, the binarization result is not overly sensitive to the sub-image size. For example, the width of the characters in the three images 10, 12 and 16 shown in FIG. 6 is not exactly 12 pixels, but nevertheless all the characters in the three binarized images 16, 18 and 20 are clear.

In the examples of FIGS. 6A, 6B and 6C, 0.85 was chosen the threshold coefficient. The binarization result is more sensitive to the threshold coefficient than to the sub-image size.

### 3—Algorithms for Border Removal

In FIGS. 6A, 6B and 6C, all three binarized images 14, 16 and 18 have a black border 26, 28 and 30 respectively surrounding their plate images 32, 34 and 36 respectively. For OCR, this is not desirable. Segmentation cannot work properly with such a border and as such it must be removed from the binarized car plate images before passing them to OCR. The algorithm for border removal will now be described in accordance with a non-restrictive illustrative embodiment of the present invention.

### 3.1 Clear Characters and Clear Border

In order to remove the black border surrounding the characters in binarized images such as car plate images, or sign images and the like, the shape of the border has to be determined.

Turning to FIG. 7, the original grayscale image 40 shows a clear border 42 surrounding the plate image 44, but in the corresponding binarized image 46, the border 48 was broken into pieces at the left portion 50 of the image 46. This type of binarized image is not optimal for border removal. Therefore, we must temporally set aside our aim in pursuit of clear characters in the binarized image, to instead focus on capturing a satisfactory clear border shape.

It was mentioned above that the result of binarization is not very sensitive to the sub-image size; nevertheless, changing the size of the sub-image does affect the result. Therefore, it is advantageous to provide a larger sub-image size when binarizing the border than the sub-image size provided when binarizing the characters. For example, in FIG. 7 the sub-image size (height and width) was 1.5 times the character width which was set at 12 pixels, providing a sub-image size of 18-by-18 pixels. This sub-image size though did not provide a satisfactory border. Therefore, to properly binarize the border 42 of the grayscale image 40 of FIG. 7, a sub-image size having a width and height that was 2.5 times the character width (12 pixels) was set thereby providing a sub-image size of 30-by-30 pixels.

FIG. 8 shows the resulting binarized image 52 having a clear border 54. Based on such a binarized image, we detect the border in image 46 of FIG. 7, When comparing the binarized image 52 of FIG. 8 with the binarized image 46 of FIG. 7, it is ascertained that in this non-limiting example it was advantageous to binarize the grayscale plate image 30 using a sub-image size of 2.5 times the plate character width (about 12 pixels) thus providing both clear characters and a clear border.

Unfortunately, the results achieved in FIG. 8 are exceptional and most times a larger sub-image will provide a clear border but not clear characters and a smaller sub-mage will provide clear characters but not a clear border.

Therefore, in an non-restrictive illustrative embodiment of the present invention, a given grayscale image of a car plate or a like sign is binarized twice using two differently sized sub-images to move from pixel to pixel during the binarization step, namely a larger sub-image size and a smaller sub-image size. The binarized image produced with the larger sub-image provides for detecting the border. The binarized image produced with the smaller sub-image provides clear characters. Since the border has been detected, and more specifically, the position of the pixels that make up this border is known, this border (i.e. the pixels) can be mapped and then removed from the binarized image that provides clearer characters. Then, the two binary images are subsequently cropped to provide a complete single binary image having both a clear border and clear characters.

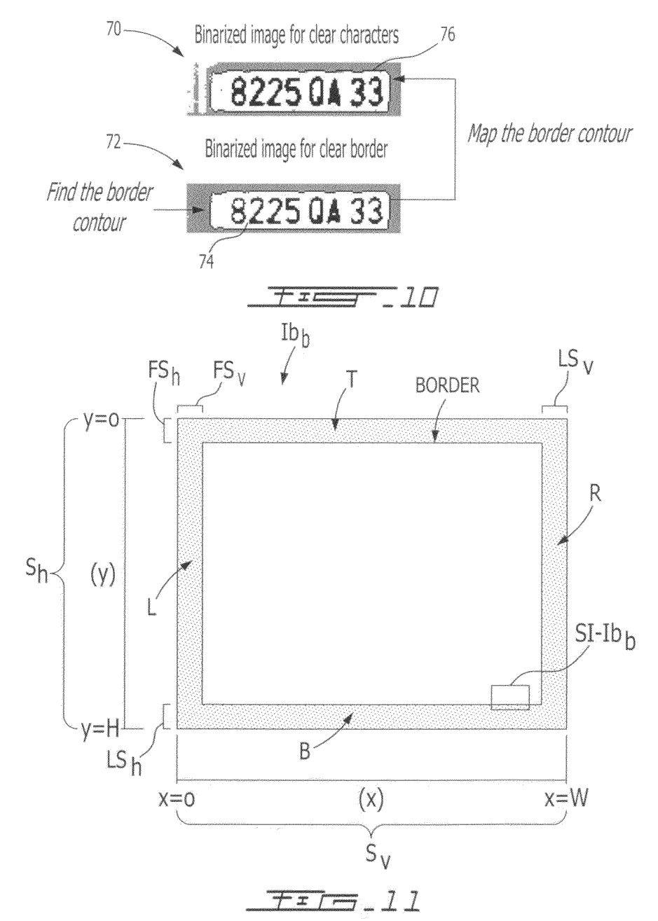

This is exemplified in FIG. 9 which shows a grayscale image 60, a first binarized image 62 and a second binarized image 64. Image 62 was obtained by binarizing the pixels of image 60 using a sub-image size of 1.5 times the character width (herein 1.5×). Image 64 was obtained by binarizing the pixels of image 60 using a sub-image size of 2.5 times the character width (herein 2.5×). Keeping in mind the character “6” and the border section 66 at the left position 68 of each of the images 60, 62 and 64, it is noted that using a sub-image size of 1.5× provides for clearer characters (as shown in image 62), whereas using a larger sub-image size (2.5×) provides for a clearer border (as shown in image 64).

Therefore image 62 (clear characters) and image 64 (clear border) should be combined to provide a complete image having both clear characters and a clear border.

### 3.2—Scheme for Border Removal

The algorithm for border removal comprises two binarization steps, one step for achieving clear characters (binarized image for clear characters) using a certain sub-image size and the other step for achieving a clear border (binarized image for clear border) using a sub-image size that is greater than the previously mentioned certain sub-image size. After producing these two binarized images, the algorithm finds the border contour on the binarized image for clear border, maps the contour on the binarized image for clear characters, and then removes the border from the binarized image for clear characters. This produces a binarized image for clear characters without a border.

FIG. 10 shows two binarized images 70 and 72 which were produced from the original grayscale image 40 shown in FIG. 7. The binarized image 72 was produced using a larger sub-image size for each pixel than the one used for the binarized image 70. As such, binarized image 70 is for clear characters and binarized image 72 is for a clear border. The border contour 74 is therefore detected on image 72. The detected border contour 74 is then mapped on image 70 thereby providing a mapped contour 76. The mapped contour 76 in the binarized image 70 is removed. The image 70 without border is then cropped with the image 72 to provide an image having clear characters (that were obtained in image 70) and a clear border (that was obtained in image 72.

### 3.3—The Algorithms

Border removal consists of two algorithms: the algorithm for border contour finding and (b) the algorithm for border white painting. These two algorithms will now be discussed.

FIG. 11 is a schematic representation of a binarized image (lb_{b}) which is used only for explanatory reasons regarding finding the border contour.

### 3.3.1—The Algorithm for Border Contour Finding

Let W and H be the width and height of the image. Furthermore, Sₕ and Sᵥ indicate, respectively, the number of horizontal lines and the number of the vertical columns to be scanned. Cₕ and Cᵥ indicate, respectively, the horizontal and vertical border density coefficients.

The following steps are performed on the binarized image for clear border.

Step 1—Binarized image for clear border: produce a binarized image for a clear border (lb_{b}) from the original grayscale image (lo) using a pre-determined sub-image size (SI-lb_{b}). In one non-limiting example, the sub-image size is 2.5 times the width of a given character XYZ in the original grayscale image (lo). A copy of this binarized image (lb_{b}) is kept.

Step 2—Border scanning: in the binarized image for clear border (lb_{b}), scan the first Sₕ pixel lines (FSₕ) and the last Sₕ pixel lines (LSₕ) to yield histograms of line black density for both the top border T and bottom border B; and scan the first Sᵥ pixel columns (FSᵥ) and the last Sᵥ pixel columns (FS_{V}) to yield histograms of column black density for both left border L and right border R.

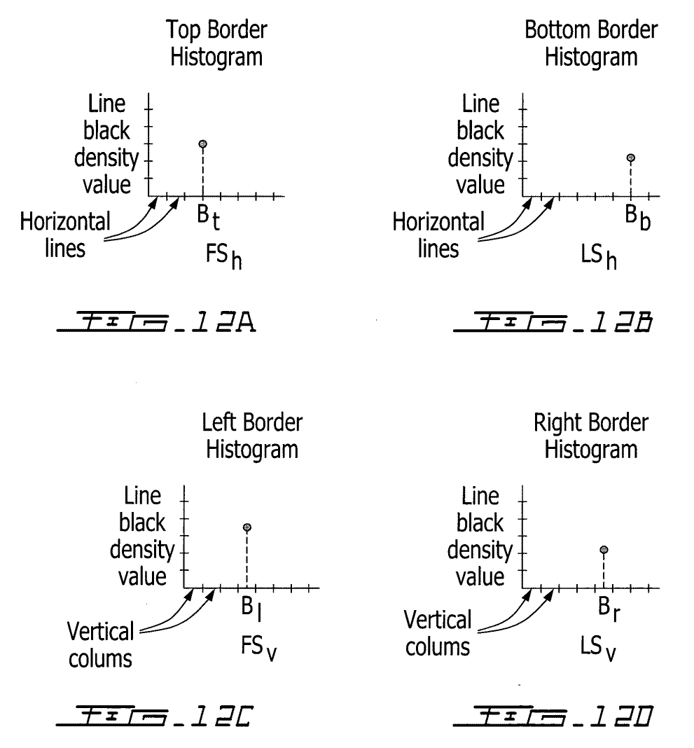

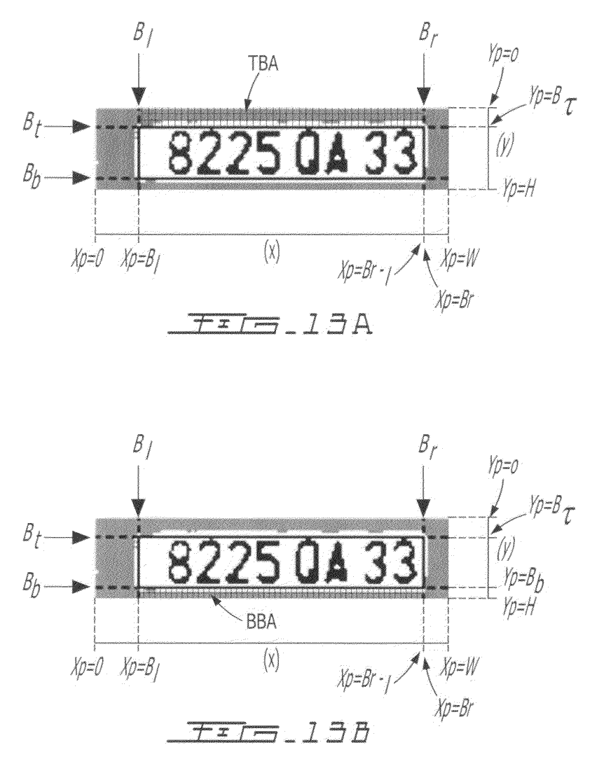

With reference to FIGS. 12A, 12B, 12C and 12D, histograms are provided for each of the top, bottom, left and right borders. The top border and bottom borders include respective first and last pixel lines FSₕ and LSₕ respectively. The left and right borders include respective first and last pixel columns FS_{V} and LS_{V} respectively. We will keep the foregoing histograms in mind as we describe step 3.

Step 3—Border Position:

(i) The top border T is scanned from its top most pixel line toward its bottom most pixel line in order to identify the first pixel line that has a line black density value that is less than W×Cₕ. Once we identify this value we determine its line number as Bₜ and stop.

(ii) The bottom border B is scanned from its bottom most pixel line toward its top most pixel line in order to identify the first pixel line that has a line black density value that is less than W×Cₕ. Once we identify this value we stop determine its line number as B_{b} and stop.

(iii) The left border L is scanned from its left most pixel line toward its right most pixel line in order to identify which pixel line that has a line black density value that is less than H×Cᵥ. Once we identify this value we determine its line number as Bₗ and stop.

(iv) The right border L is scanned from its right most pixel line toward its left most pixel line in order to identify the first pixel line that has a line black density value that is less than H×Cᵥ. Once we identify this value we determine its line number as Bₗ and stop.

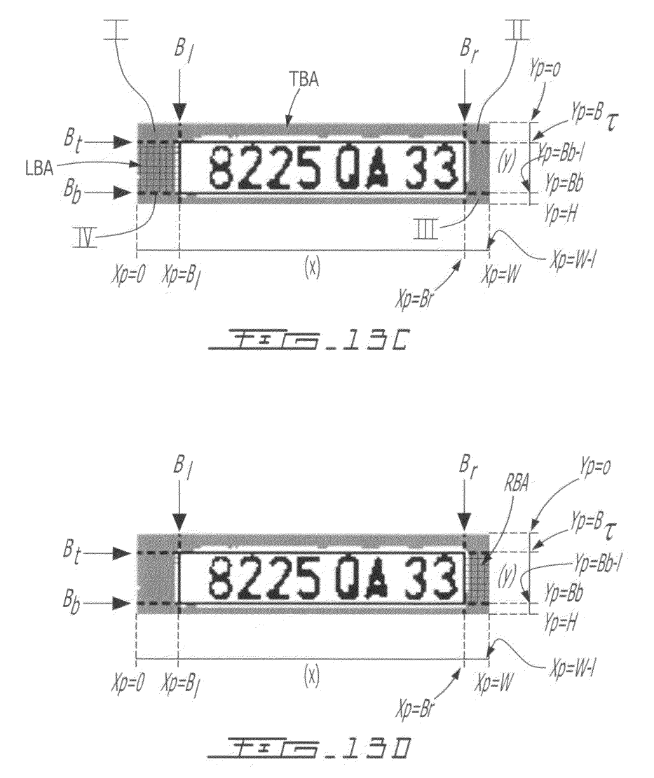

FIGS. 13A, 13B, 13C and 13D show the border position of each line number Bₜ, B_{b}, Bₗ, and Bᵣ.

### 4—Border Contour:

After having identified the border position line number, as we can see from FIGS. 13A-13D these positions do not exactly represent the contour of the border which is not in a straight line but in a curved line about the characters. Therefore, with particular reference to FIGS. 13A-13D, we need to identify the contour of each border side, namely the top border, the bottom border, the left border and the right border.

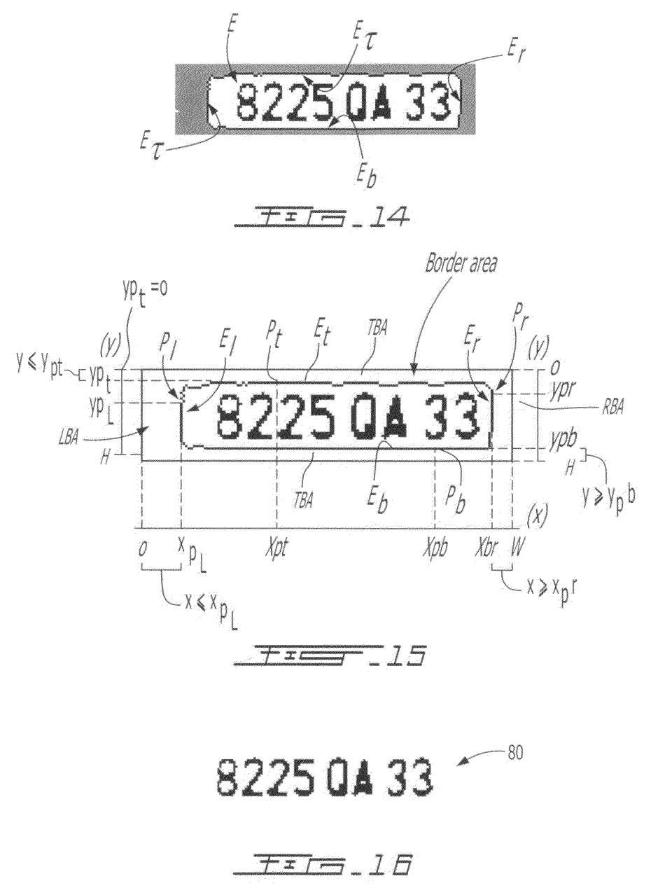

The top border contour: With reference to FIG. 12A, we scan every vertical pixel column from the column position xₚ=Bₗ to xₚ=Bᵣ−1 within the top border area (TBA) defined from the position yₚ=Bₜ to yₚ=0, on each pixel column, we check each pixel position (xₚ, yₚ) until we identify a first black pixel, once we identify this first black pixel, we stop and move onto the next column and so one until we have identified a series of these black pixels which allows us to map out top border contour Eₜ as shown in FIG. 14.

The bottom border contour: With reference to FIG. 12B, we scan every vertical pixel column from the column position xₚ=Bₗ to xₚ=Bᵣ−1 within the bottom border area (BBA) defined from the position yₚ=B_{b} to yₚ=H−1, on each pixel column, we check each pixel position (xₚ, yₚ) until we identify a first black pixel, once we identify this first black pixel, we stop and move onto the next column and so one until we have identified a series of these black pixels which allows us to map out the bottom border contour E_{b} as shown in FIG. 14.

The left border contour: With reference to FIG. 12C, we scan every vertical pixel line from the line position yₚ=Bₜ to yₚ=B_{b}−1 within the left border area (LBA) defined from the position xₚ=Bₗ to xₚ=0, on each pixel line, we check each pixel position (xₚ, yₚ) until we identify a first black pixel, once we identify this first black pixel, we stop and move onto the next line and so one until we have identified a series of these black pixels which allows us to map out the left border contour Eₗ, as shown in FIG. 14.

The right border contour: With reference to FIG. 12D, we scan every vertical pixel line from the line position yₚ=Bₜ to yₚ=B_{b}−1 within the right border area defined from the position xₚ=Bᵣ to xₚ=W−1, on each pixel line, we check each pixel position (xₚ, yₚ) until we identify a first black pixel, once we identify this first black pixel, we stop and move onto the next line and so one until we have identified a series of these black pixels which allows us to map out the left border contour as shown in FIG. 14.

The four steps described above provide to identify the border contour E as shown in FIG. 14. The border contour consists of four sequences of pixel positions, they are the top border contour, bottom border contour, left border contour and right border contour, Eₜ, E_{b}, Eₗ, and Eᵣ respectively. The position coordinates kept in Eₜ, E_{b}, Eₗ, and Eᵣ draw a curve E.

### 3.3.1 The Algorithm for Border White Painting

Once the border contour is found, the four borders are painted white (i.e. removed).

More specifically, the border contour E that was found on the binarized image for clear border (e.g. image 72 in FIG. 10) is mapped out on the binarized image obtained for clear characters (e.g. image 70 in FIG. 10) since we have identified the coordinates of each of the pixels of Eₜ, E_{b}, Eₗ, and Eᵣ we can not find these pixels on the image obtained for clear characters and paint them white. Of course its not only the pixels of Eₜ, E_{b}, Eₗ, and Eᵣ that need to be painted white its all the pixels behind the contour (the border area see FIG. 15). Therefore border painting is performed on the image obtained for clear characters.

All the actions described below are performed in the binarized image for clear characters

With reference to FIG. 15, the algorithm for border painting is described as follows:

1. The top border area (TBA): Pₜ (xₚₜ, yₚₜ) is a given pixel in the top border contour line Eₜ, pixel Pₜ as well as all pixels that are on the same column and above Pₜ, (pixels p(x, y) that satisfy x=xₚₜ and y≦yₚₜ) are painted white.

2. The bottom border area (BBA): P_{b} (x_{pb}, Y_{Pb}) is a given pixel in the bottom border contour line E_{b}, pixel P_{b}, as well as all pixels that are on the same column and below P_{b}, (pixels p (x, y) that satisfy x=x_{pb} and y≧y_{pb}) are painted white.

3. The left border area (LBA): Pₗ (xₚₗ, Yₚₗ) is a given pixel in the left border contour line Eₗ, pixel Pₗ, as well all pixels that are on the same line and left of Pₗ, (pixels p(x, y) that satisfy x≧xₚₗ and y=yₚₗ) are painted white.

4. The right border area (RBA): Pᵣ (xₚᵣ, yₚᵣ) is a given pixel in the right border contour line Eᵣ, pixel Pᵣ, as well as all pixels that are on the same line and left of Pᵣ, (pixels p(x, y) that satisfy x≧xₚᵣ and y=yₚx≦xₚₗ and y=yₚₗ) are painted white.

With reference to FIG. 13C, the remaining four corners I, II, III and IV are then painted white.

With reference to FIG. 16, the foregoing provides a borderless binarized image 80 with clear characters that is cropped with a binarized image having a clear border (e.g. 72 in FIG. 10) to produce an image with both clear characters and a clear border.

### EXAMPLES

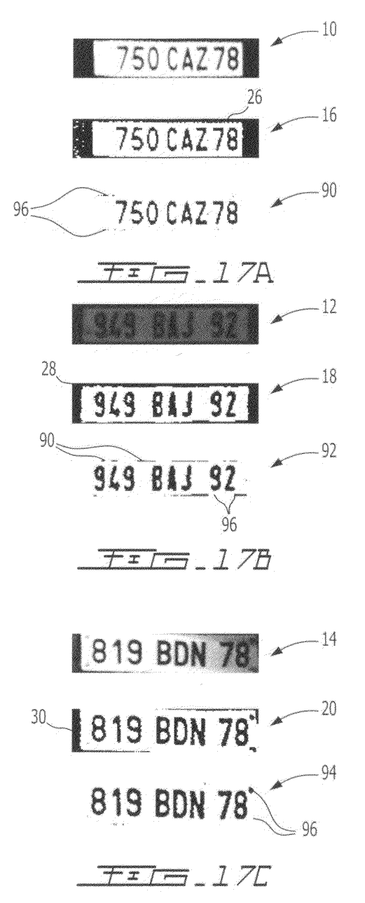

FIGS. 17A, 17B and 17C show the original grayscale images 10, 12 and 14, respectively and their binarized images 16, 18 and 20 obtained for clear characters previously discussed in FIGS. 6A-6B. FIGS. 17A, 17B and 17C show that the corresponding black borders 26, 28 and 30 can be removed from the images 16, 18 and 20 to provide corresponding images 90, 92 and 94, respectively without borders. FIGS. 17A, 17B and 17C show that the borders 26, 28 and 30 were well removed for the three car plate images. There are some dirt dots 96 on the border removed images 90, 92 and 94, which is due to the use two binarized images as previously explained. This “dirt” is just the little difference between the two binarized image versions.

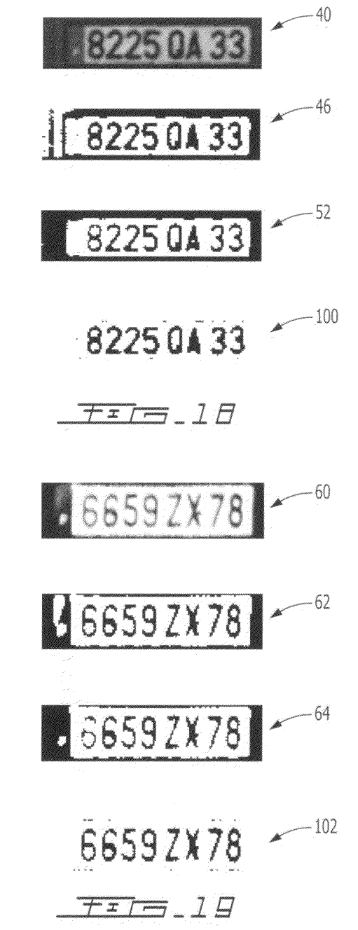

FIGS. 18 and 19 show the original grayscale images 40 and 60 respectively as well as their corresponding binarized images for clear characters 46 and 62, respectively, and their corresponding binarized images for a clear borders 52 and 64 respectively all of which were previously discussed herein with reference to FIGS. 7, 8 and 9. FIGS. 18 and 19 now show that the borders of images 46 and 62 can be removed to produce images 100 and 102 respectively which have clear characters but no borders and which can be cropped with images 52 and 64 to produce images with both clear borders and clear characters.

### 3.4 The Parameters for Border Removal

To remove the black border in car plate images, the key procedure is to find the border contour. In the algorithm for border contour finding, we need four parameters: Sₕ, Sᵥ, Cₕ, and Cᵥ.

Sₕ is the number of scanning lines for getting the black density histogram for the top and bottom border, and Sᵥ is the number of scanning columns for getting the black density histogram for the left and right border. In one embodiment, ⅓ of the image height (H) for Sₕ and ⅓ of the image width (W) for Sᵥ are set. In another embodiment, Sₕ is ½ of the image height (H) and Sᵥ is ½ of the image width (W).

Cₕ, and Cᵥ are constants in the algorithm. They are used to precisely locate all four borders as described in Step 3 of the algorithm for border contour finding. In one embodiment, Cₕ=35% and Cᵥ=45%.

For example, for top border, we scan the pixel lines, from the line 0 going down line by line, when we meet the first line (indicating Nₜ as its line number) which has a black density smaller than 35% of the image width (W), that means the top border consists of the pixel lines with their line number between 0 to N−1. For the bottom border we scan the pixel lines, from the line H going up line by line, when we meet the first line (Nb) which has a black density smaller than 35% of the image width (W), that means the bottom border consists of the pixel lines with their line number between H to N−1. For the left border we scan the pixel columns, from the column 0 going right column by column, when we meet the first column (NI) which has a black density smaller than 45% of the image height (H), that means the left border consists of the pixel columns with their column number between 0 to NI−1. For the right border we scan the pixel columns, from the column W going left line by line, when we meet the first column (Nr) which has a black density smaller than 45% of the image height (H), that means the right border consists of the pixel columns with their column number between W to Nr−1.

### 4.—Notes on the Algorithm for Binarization 4.1—Binarizing a General Grayscale Image

In the examples so far, we have seen the results of the binarization algorithm on car plate images. Of course, the method disclosed herein is also useful on other grayscale images.

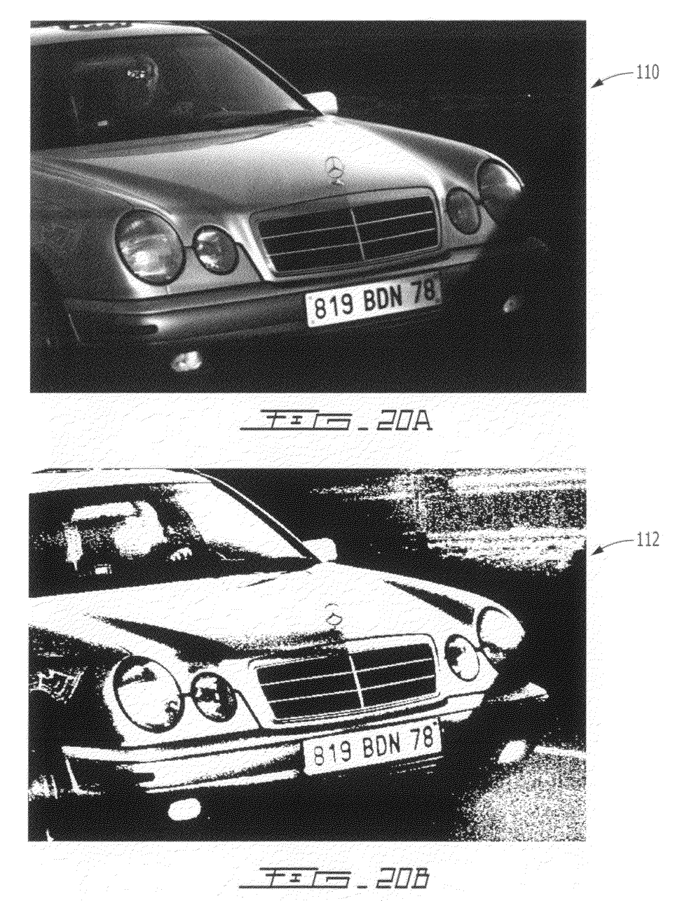

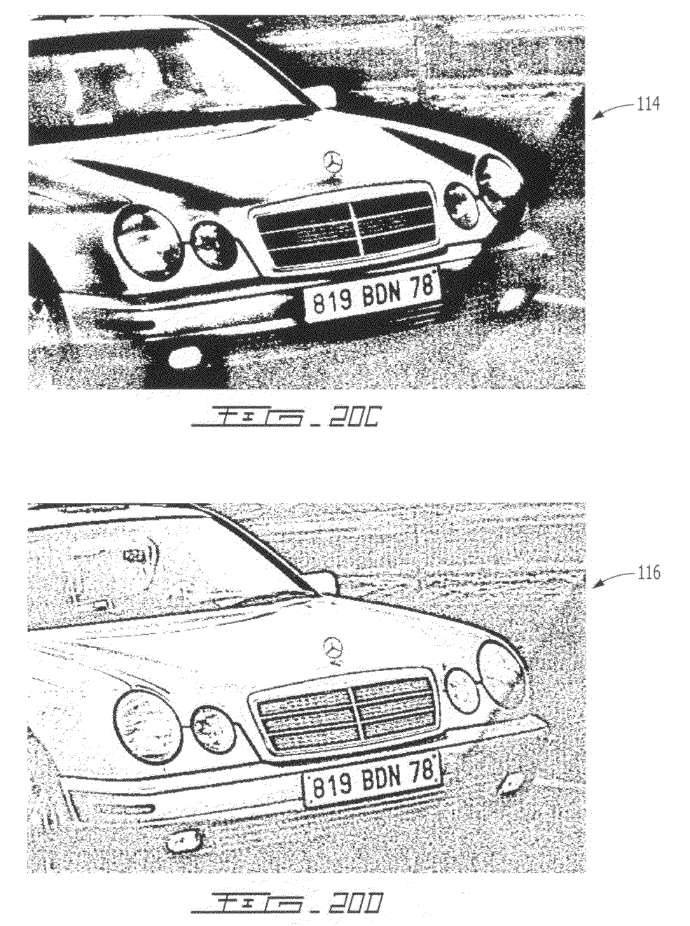

FIG. 20A shows an original grayscale image 110 having a width of 702 pixels and a height of 479 pixels. FIG. 20B is a first binarized image 112 of image 110 which was obtained using dynamic sub-image division with a sub-image having a size that was ¼ the image width (175 pixels) and ¼ the image height (118 pixels). FIG. 20C shows a second binarized image 114 of image 110 which was obtained using dynamic sub-image division with a sub-image having a size that was ⅛ the image width (87 pixels) and ¼ the image height (59 pixels). FIG. 20D shows a third binarized image 116 of image 110 which was obtained using dynamic sub-image division with a sub-image having a size of 10×10 pixels. Therefore, using smaller sub-images provides for more details. This is especially useful for images that were captured in the dark as is often the case with surveillance cameras.

More examples are shown in FIGS. 21A to 23B.

FIG. 21A shows an original grayscale image 120 having an image width of 702 pixels and an image height of 479 pixels. As is shown, image 120 is black and all that can be seen is the car plate. When binarizing image 120 with a dynamic sub image division using a sub-image size of 10×10 pixies, we obtain the binarized image 122 shown in FIG. 21B.

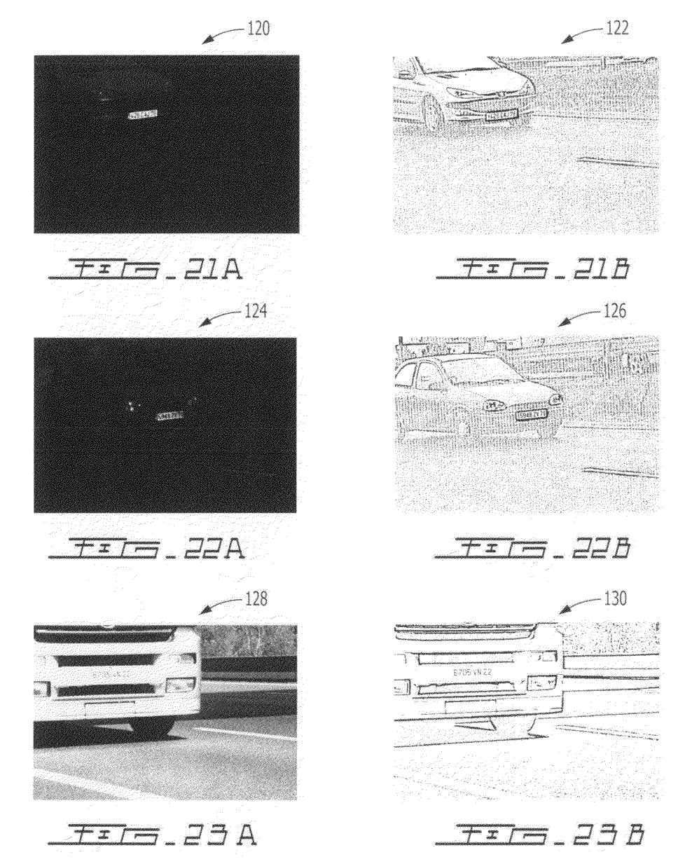

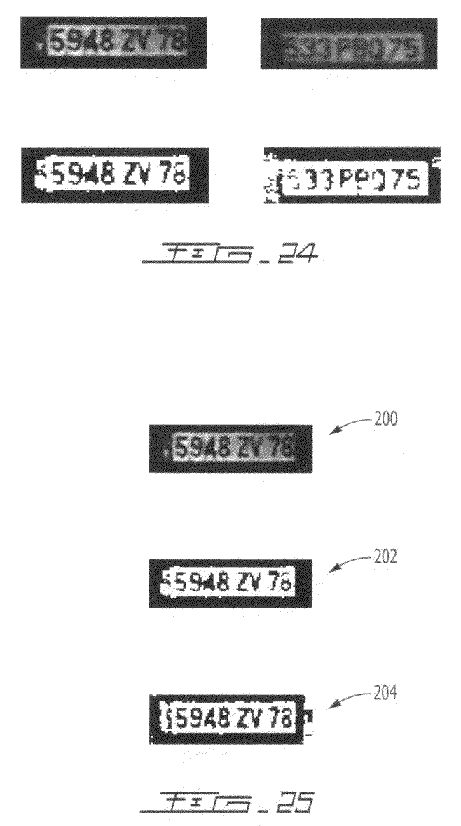

FIGS. 22A and 23A are also grayscale images 124 and 126 respectively having an image width of 702 pixels and an image height of 479 pixels, their corresponding binarized images, 128 and 130, respectively shown in FIGS. 22B and 23B were obtained with sub-image sizes of 10×10 pixels.

### 4.2 About Small Size Characters

To get good characters quality for OCR, the size of characters in the image to be binarized should not be too small. If the size of the characters on a car plate, for example, is too small and the contrast of foreground and background is also too small, the result of binarization may not be good as shown in the examples of FIG. 24.

### 4.3 About the Sub-Image Size

Generally, the result of binarization is not very sensitive to the sub-image size. However, when character size is small, the result becomes more sensitive to the sub-image size.

As was previously discussed, the width of the characters in most of car plate images is about 12 pixels, the sub-image width we set, in accordance with an illustrative embodiment was 18 pixels (1.5 times of the character width). Turning to FIG. 25, a car plate grayscale image 200 is shown, having a character width of 7 pixels. A sub-image size of 1.5 times the character width was used (10.5×10.5 pixels) which resulted in a binarized image 202. Another binarized image 204 was produced using a sub-image size of 10×10 pixels. This second image 204 was superior to image 202.

### 4.4 Sub-Image Size

It was discussed herein how the binarization results depend on the sub-image size. To get better binarization results for car plates, it is better to set the sub-image size dynamically for each plate. That is if we can get the character width before setting the sub-image size, we will get better binarized image for each plate.

It is possible to estimate the character width for getting better binarized image with the binarization algorithm provided herein.

### 4.5 Time

The amount of time for binarizing an image is dependent on the sub-image size, the larger the size is the more time the binarization consumes. In one embodiment, it takes almost 1 second when binarizing a whole car image with a sub-image width and height of 10 pixels. It is possible to improve binarization time consuming by finding an optimal sub-image size with the aid of the algorithm provided herein.

### CONCLUSIONS

The algorithms disclosed herein are easy to implement, and the results are good enough for OCR to recognize the characters in an image.

To get good binarized image results, the sub-image size and the threshold coefficient are important parameters. The threshold coefficient is used to calculate the threshold for each pixel from the average color value in a sub-image.

The binarization result is not very sensitive on the sub-image size, but the sub-image size does affect the binarization result when the characters in the images are too small. It also affects the result on big black masses. For big black masses, the result will be better if the sub-image size is not smaller than the masses size.

The algorithm for border removal showed good results in the border removed binarized images. The algorithm also needs the width of the characters in the image to be binarized.

Since the size of certain similar images, such as car plate images varies by the same token the characters or other information width also varies in these images, hence, a preset sub-image size cannot give a good character shape for all images. Dynamically determining the sub-image size for each image to be binarized will well solve this problem.

In accordance with an illustrative embodiment of the present invention, there is also provided a device for performing the methods disclosed herein. This device can include a controller for performing steps of the methods disclosed herein as well as a scanner and an interface for displaying results and/or a printer. For example, the controller can be a data processor such as a computer, the interface can be a screen.

It should be noted that the various components and features of the embodiments described above can be combined in a variety of ways so as to provide other non-illustrated embodiments within the scope of the invention.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention.

What is claimed is:

1. A method of binarizing a grayscale image into a black and white binary image, said method comprising:
selecting a given pixel (P) in the grayscale image;
determining the color value (V_{P}) of P;
providing a sub-image (Subl_{P}) comprising P as well as a number of neighboring pixels;
determining the average color value (A_{P}) of all the pixels in Subl_{P};
calculating the threshold (T_{P}) of P by multiplying A_{P} by a threshold coefficient (C);
converting P to black if V_{P}≦T_{P} or to white if V_{P}>T_{P};
repeating the above steps for each pixel of the grayscale image that is desired to be converted; and
obtaining a resulting black and white binarized image.

2. A method according to claim 1, wherein each sub-image provided for the grayscale image comprises the same number of pixels.

3. A method according to claim 1, wherein the given pixel (P) is positioned in the centre of the sub-image (Subl_{P}).

4. A method according to claim 1, wherein the threshold coefficient (C) is a predetermined percentage.

5. A method according to claim 1, wherein the height and the width of the grayscale image are H and W respectively, the position of P being (x_{P}, y_{P}) with x_{P} being a position along W and a y_{P} being a position along H, the sub-image Subl_{P} having a height Hs which is a portion of H and a width Ws which is a portion of W, and defining a left border (l_{P}) and a right border (r_{P}) positioned along W, and a top border (tp) and bottom border (b_{P}) positioned along H.

6. A method according to claim 5, wherein the position of the left border (l_{P}) is calculated as follows:
$${I}_{p} = \{ \begin{matrix}0 , & if & 0 \leq {x}_{p} < Ws / 2 ; \\ {x}_{p} - Ws / 2 , & if & Ws / 2 \leq {x}_{p} < W - Ws / 2 ; \\ W - Ws / 2 & if & W - Ws / 2 \leq {x}_{p} < W ;\end{matrix}$$

7. A method according to claim 5, wherein the position of the top border (tp) is calculated as follows:
$${t}_{p} = \{ \begin{matrix}0 , & if & 0 \leq {y}_{p} < Hs / 2 ; \\ {y}_{p} - Hs / 2 , & if & Hs / 2 \leq {y}_{p} < H - Hs / 2 ; \\ H - Hs / 2 & if & H - Hs / 2 \leq {y}_{p} < H ;\end{matrix}$$

8. A method according to claim 5, wherein the position of the top border (r_{P}) is calculated as follows:
$${r}_{p} = \{ \begin{matrix}Ws , & if & 0 \leq {x}_{p} < Ws / 2 ; \\ {x}_{p} + Ws / 2 , & if & Ws / 2 \leq {x}_{p} < W - Ws / 2 ; \\ W , & if & W - Ws / 2 \leq {x}_{p} < W ;\end{matrix}$$

9. A method according to claim 5, wherein the position of the bottom border (b_{P}) is calculated as follows:
$${b}_{p} = \{ \begin{matrix}Hs , & if & 0 \leq {y}_{p} < Hs / 2 ; \\ {y}_{p} + Hs / 2 , & if & Hs / 2 \leq {y}_{p} < H - Hs / 2 ; \\ H , & if & H - Hs / 2 \leq {y}_{p} < H ;\end{matrix}$$

10. A method according to claim 1, wherein said grayscale image comprises a border surrounding characters, said method further comprising:
obtaining a first and second binary image, wherein one of said first and second binary images provides a clear border and the other of the first and second binary images provides clear characters; and
combining the first and second binary images to obtain a combined binary image providing for both a clear border and clear characters.

11. A method according to claim 12, wherein one of the first and second images is obtained by using a sub-image size containing a given number of pixels and the other of said first and second binary images is obtained by using another sub-image size containing a different number of pixels.

12. A method according to claim 10, wherein the one of the first and second images that provides a clear border is obtained with a sub-image comprising more pixels than the other of the first and second binary images that provides for clear characters.

13. A method according to claim 10, wherein the method further comprises
removing the border in the binary image with clear characters to provide a binary image without a border; and
combining the binary image without a border with the binary image providing a clear border so as to obtain the combined binary image having both a clear border and clear characters.

14. A method according to claim 13, wherein removing the border comprises:
finding the border contour on the binary image providing a clear border, wherein the binary image providing a clear border comprises top, bottom, left and right borders;
mapping the found border contour on the binary image providing clear characters; and
painting white the mapped border contour on the binary image providing clear characters.

15. A method according to claim 14, wherein finding the border comprises:
obtaining the height H and width W of the binary image providing a clear border;
providing horizontal and vertical border density coefficients Cₕ, and Cᵥ respectively; and
identifying in the binary image providing a clear border:
the line number (Bₜ) of a pixel line in the top border having a line black density value that is less than W×Cₕ;
the line number (B_{b}) of a pixel line in the bottom border having a line black density value that is less than W×Cₕ;
the column number (Bₗ) of a pixel column in the left border having a line black density value that is less than H×Cᵥ;
the column number (Bᵣ) of a pixel column in the right border having a line black density value that is less than H×Cᵥ;
thereby providing the border positions Bₜ, B_{b}, Bₗ, and Bᵣ.

16. A method according to claim 15, wherein the position of a pixel P in the binary image providing a clear border is (xₚ, yₚ), wherein xₚ is a pixel column position along W and yₚ is a pixel line position along H, wherein finding the border contour comprises:
identifying in the binary image providing a clear border:
the first black pixel in each vertical pixel column from the column position at xₚ=Bₗ to xₚ=Bᵣ−1 within the top border area defined from the position yₚ=Bₜ to yₚ=0 thereby providing the top border contour Eₜ;
the first black pixel in each vertical pixel column from the column position at xₚ=Bₗ to xₚ=Bᵣ−1 within the bottom border area defined from the position yₚ=B_{b} to yₚ=H−1 thereby providing the bottom border contour E_{b},
the first black pixel in each vertical pixel line from the line position at yₚ=Bₜ to yₚ=B_{b}−1 within the left border area defined from the position xₚ=Bₗ to xₚ=0, thereby providing the left border contour Eₗ; and
the first black pixel in each vertical pixel line from the line position at yₚ=Bₜ to yₚ=B_{b}−1 within the right border area defined from the position xₚ=Bᵣ to xₚ=W−1 thereby providing the right border contour Eᵣ.

17. A method according to claim 16, wherein painting white the mapped border contour on the binary image providing clear characters comprises:
mapping the top, bottom, left and right border contours Eₜ, E_{b}, Eₗ, and Eᵣ on the binary image providing clear characters;
painting white every pixel in the top border contour Eₜ as well as all the pixels in the same column with and above each pixel in the top border contour Eₜ;
painting white every pixel in the bottom border contour E_{b} as well as all the pixels in the same column with and below each pixel in the bottom border contour E_{b};
painting white every pixel in the left border contour Eₗ as well as all the pixels in the same line with and to the left of each pixel in the left border contour Eₗ and
painting white every pixel in the right border contour Eras well as all the pixels in the same line with and to the right of each pixel in the right border contour Eᵣ.

18. A method of binarizing a grayscale image comprising a border surrounding characters into a black and white binary image with a clear border and clear characters, said method comprising:
obtaining first and second binary images of the grayscale image by dividing the grayscale image into sub-images for determining if a pixel is to be converted into white or black based on its threshold as compared to the average colour value of its sub-image, wherein one of the first and second binary images provides a clear border and the other of the first and second binary images provides clear characters;
removing the border in the binary image providing characters to provide a binary image without a border; and
combining the binary image without a border with the binary image having a clear border so as to obtain a combined binary image having both a clear border and clear characters.

19. A method according to claim 18, wherein the binary image providing a clear border is obtained by using a given sub-image of the same size for each pixel to be converted, and the binary image for providing clear characters is obtained by using another sub-image of the same size for each pixel to be converted, wherein said given sub-image is larger in size than said another sub-image.

20. A method according to claim 18, wherein removing the border comprises:
finding the border contour on the binary image providing a clear border, wherein the binary image providing a clear border comprises top, bottom, left and right borders;
mapping the found border contour on the binary image providing clear characters; and
painting white the mapped border contour on the binary image providing clear characters.

21. A method according to claim 19, wherein finding the border contour comprises:
obtaining the height H and width W of the binary image providing a clear border;
providing horizontal and vertical border density coefficients Cₕ, and Cᵥ respectively; and
identifying in the binary image providing a clear border:
the line number (Bₜ) of a pixel line in the top border having a line black density value that is less than W×Cₕ;
the line number (B_{b}) of a pixel line in the bottom border having a line black density value that is less than W×Cₕ;
the column number (Bₗ) of a pixel column in the left border having a line black density value that is less than H×Cᵥ;
the column number (Bᵣ) of a pixel column in the right border having a line black density value that is less than H×Cᵥ;
thereby providing the border positions Bₜ, B_{b}, Bₗ, and Bᵣ.

22. A method according to claim 21, wherein the position of a pixel P in the binary image providing a clear border is (xₚ, yₚ), wherein xₚ is a pixel column position along W and yₚ is a pixel line position along H, wherein finding the border contour comprises:
identifying in the binary image providing a clear border:
the first black pixel in each vertical pixel column from the column position at xₚ=Bₗ to xₚ=Bᵣ−1 within the top border area defined from the position yₚ=Bₜ to yₚ=0 thereby providing the top border contour Eₜ;
the first black pixel in each vertical pixel column from the column position at xₚ=Bₗ to xₚ=Bᵣ−1 within the bottom border area defined from the position yₚ=B_{b} to yₚ=H−1 thereby providing the bottom border contour E_{b},
the first black pixel in each vertical pixel line from the line position at yₚ=Bₜ to yₚ=B_{b}−1 within the left border area defined from the position xₚ=Bₗ to xₚ=0, thereby providing the left border contour Eₗ; and
the first black pixel in each vertical pixel line from the line position at yₚ=Bₜ to yₚ=B_{b}−1 within the right border area defined from the position xₚ=Bᵣ to xₚ=W−1 thereby providing the right border contour Eᵣ.

23. A method according to claim 22, wherein painting white the mapped border contour on the binary image providing clear characters comprises:
mapping the top, bottom, left and right border contours Eₜ, E_{b}, Eₗ, and Eᵣ on the binary image providing clear characters;
painting white every pixel in the top border contour Eₜ as well as all the pixels in the same column with and above each pixel in the top border contour Eₜ;
painting white every pixel in the bottom border contour E_{b} as well as all the pixels in the same column with and below each pixel in the bottom border contour Eₜ;
painting white every pixel in the left border contour Eₗ as well as all the pixels in the same line with and to the left of each pixel in the left border contour Eₗ and
painting white every pixel in the right border contour Eras well as all the pixels in the same line with and to the right of each pixel in the right border contour Eᵣ.

24. A device for binarizing a grayscale image into a black and white binary image, said device comprising;
a scanner for scanning the pixels of the grayscale image; and
a controller for receiving information from the scanner, said controller:
selecting a given pixel (P) in the grayscale image;
determining the color value (V_{P}) of P;
providing a sub-image (Sublₚ) comprising P as well as a number of neighbouring pixels;
determining the average color value (A_{P}) of all the pixels in Sublₚ;
calculating the threshold (T_{P}) of P by multiplying A_{P} by a threshold coefficient (C);
converting P to black if V_{P}≦T_{P} or to white if V_{P}>T_{P};
repeating the above steps for each pixel of the grayscale image that is desired to be converted; and
obtaining a resulting black and white binarized image.

25. A device for binarizing a grayscale image comprising a border surrounding characters into a black and white binary image with a clear border and clear characters, said device comprising:
a scanner for scanning the pixels of the grayscale image;
a controller for receiving information from the scanner, said controller:
obtaining first and second binary images of the grayscale image by dividing the grayscale image into sub-images for determining if a pixel is to be converted into white or black based on its threshold as compared to the average colour value of its sub-image, wherein one of the first and second binary images provides a clear border and the other of the first and second binary images provides clear characters;
removing the border in the binary image providing characters to provide a binary image without a border; and
combining the binary image without a border with the binary image having a clear border so as to obtain a combined binary image having both a clear border and clear characters.
